(19) United States
(12) Patent Application Publication
(10) Pub. No.: US 2026/0321839 A1
(43) Pub. Date: Oct. 15, 2026

(54) BATTERY PACK AND ELECTRIC PRODUCT INCLUDING THE BATTERY PACK

(71) Applicant: SAMSUNG SDI CO., LTD., Yongin-si (KR)

(72) Inventor: CHUNGSU HONG, Yongin-si (KR)

(21) Appl. No.: 19/642,931

(22) Filed: Apr. 9, 2026

(30) Foreign Application Priority Data
Apr. 11, 2025 (KR) 10-2025-0047650

(51) Int. Cl. H01M 50/24; A62C 3/16; A62C 31/00; B60L 50/64; H01M 10/48; H01M 50/209; H01M 50/249; H01M 50/682

(52) U.S. Cl. CPC H01M 50/24; A62C 3/16; A62C 31/005; B60L 50/64; H01M 10/482; H01M 10/486; H01M 50/209; H01M 50/249; H01M 50/682; H01M 2220/20

(57) ABSTRACT

A battery pack includes a pack housing and a plurality of battery cells accommodated in the pack housing. A spraying unit including a flow tube is arranged inside the pack housing. The spraying unit is configured to adjust a spraying path to cause a fire extinguishing agent to be sprayed toward any one of the battery cells.

### CROSS-REFERENCE TO RELATED APPLICATION

This application is based on and claims priority under 35 U.S.C. §119 to Korean Patent Application No. 10-2025-0047650, filed on Apr. 11, 2025, in the Korean Intellectual Property Office, the disclosure of which is incorporated by reference herein in its entirety.

### BACKGROUND

### 1. Field

The disclosure relates to a battery pack and an electronic device including the battery pack.

### 2. Description of the Related Art

Generally, secondary batteries refer to batteries that are rechargeable a plurality of times. Recently, secondary batteries have been applied to various technical fields across industries such as electricity, electronics, communications, computers, etc.

Secondary batteries are widely used as an energy source for mobile electronic devices such as digital cameras, cell phones, and laptop computers, and are also being uses an energy source for electric vehicles, etc., which are a solution to air pollution problems caused by gasoline and diesel internal combustion engines using fossil fuels.

Small mobile devices such as mobile phones may operate for a certain amount of time based on the output and capacity of a single battery. For electric products requiring long-term driving and high-power operations such as electric vehicles, hybrid vehicles, etc., which consume a lot of power, a secondary battery of a module or pack type including a plurality of batteries is preferred due to the provision of increased output and capacity, and the output voltage and/or output current may be increased with the number of built-in batteries.

The information disclosed in the technology section serves as the background of the disclosure is only for improving the understanding of the background of the disclosure. It may include information that does not constitute prior art.

### SUMMARY

Embodiments of the present disclosure provide a battery pack in which a spray path may be adjusted to cause a fire extinguishing agent to be sprayed toward any one of a plurality of battery cells, thereby enabling rapid fire suppression in the early stage and reducing the cost of replacing battery cells after the fire suppression.

The problems that the present disclosure aims to solve are not limited to the problems mentioned above, and other problems and advantages of the disclosure that are not mentioned may be understood through the following description and may be understood more clearly by the examples of the disclosure.

According to an aspect of the disclosure, a battery pack includes a pack housing, a plurality of battery cells accommodated in the pack housing, and a spraying unit including a flow tube arranged inside the pack housing, the spraying unit being configured to adjust a spraying path to cause a fire extinguishing agent to be sprayed toward any one of the battery cells.

In an embodiment, a plurality of spraying units may be provided, and the spraying units may be spaced apart with the battery cells between the spraying units.

In an embodiment, the flow tube is hollow inside such that the fire extinguishing agent flows through the flow tube and a spray body is connected to the flow tube and is configured to spray the fire extinguishing agent toward the battery cell.

In an embodiment, the spray body may be rotatably connected to the flow tube and be capable of adjusting the spraying path of the fire extinguishing agent.

In an embodiment, the spraying unit may further include a pressurizing unit that is connected to the flow tube and configured to supply pressure to the fire extinguishing agent flowing in the flow tube.

In an embodiment, the battery pack may further include a guiding unit arranged between the spraying unit and the battery cell, the guiding unit being configured to guide the fire extinguishing agent sprayed from the spraying unit to the battery cells.

In an embodiment, the guiding unit may include a guide plate covering an outer side of the plurality of battery cells and a guide body connected to the guide plate and configured to allow the fire extinguishing agent to pass therethrough.

In an embodiment, a plurality of guide bodies each of which corresponds to one of the battery cells.

In an embodiment, the battery pack may further include a temperature sensor unit arranged inside the pack housing and configured to detect a temperature of the battery cells.

In an embodiment, the battery pack may further include a control unit electrically connected to the spraying unit and configured to control a spraying path of the fire extinguishing agent.

According to another aspect of the disclosure, an electric product includes a battery pack configured to supply power, in which the battery pack includes a a pack housing, plurality of battery cells accommodated in the pack housing, and a spraying unit including a flow tube arranged inside the pack housing, the spraying unit being configured to adjust a spraying path to cause a fire extinguishing agent to be sprayed toward any one of the battery cells.

In an embodiment, a plurality of spraying units may be provided, and the plurality of spraying units may be spaced apart with the battery cells between the spraying units.

In an embodiment, the flow tube is hollow such that the fire extinguishing agent flows through the flow tube, and a spray body is connected to the flow tube and is configured to spray the fire extinguishing agent toward the battery cells.

In an embodiment, the spray body may be rotatably connected to the flow tube and be capable of adjusting the spraying path of the fire extinguishing agent.

In an embodiment, the spraying unit may further include a pressurizing unit that is connected to the flow tube and configured to supply pressure to the fire extinguishing agent flowing in the flow tube.

In an embodiment, the battery pack may further include a guiding unit arranged between the spraying unit and the battery cell, the guiding unit being configured to guide the fire extinguishing agent sprayed from the spraying unit to the battery cells.

In an embodiment, the guiding unit may include a guide plate covering an outer side of the plurality of battery cells and a guide body connected to the guide plate and configured to allow the fire extinguishing agent to pass therethrough.

In an embodiment, a plurality of guide bodies may be provided to correspond to the plurality of battery cells.

In an embodiment, the battery pack may further include a temperature sensor unit arranged inside the pack housing and configured to detect a temperature of the battery cells.

In an embodiment, the battery pack may further include a control unit electrically connected to the spraying unit and configured to control the spraying path of the fire extinguishing agent.

### BRIEF DESCRIPTION OF THE DRAWINGS

The drawings illustrate preferred embodiments of the disclosure and serve to further convey technical ideas of the disclosure together with the detailed description . The disclosure should not be construed as being limited to the embodiments depicted in the drawings.

FIG. 1 is a perspective view of a vehicle including a battery pack according to an embodiment of the disclosure;

FIG. 2 is a perspective view of a battery pack according to an embodiment of the disclosure;

FIG. 3 is a perspective view of a battery cell according to an embodiment of the disclosure;

FIG. 4 is a cross-sectional view of the battery cell of FIG. 3 along a line II-II';

FIG. 5 is an exploded perspective view of a battery pack according to an embodiment of the disclosure;

FIG. 6 is a cross-sectional view of the battery pack of FIG. 2 along a line I-I';

FIG. 7 is an enlarged view of a portion A of FIG. 6; and

FIG. 8 is a block diagram of a control unit according to an embodiment of the disclosure.

### DETAILED DESCRIPTION

Hereinafter, embodiments of the disclosure will be described in detail with reference to the accompanying drawings. The terms and words used in the present disclosure should not be construed as being limited to ordinary or dictionary meanings, and should be interpreted as meanings and concepts consistent with the technical idea of the disclosure based on the principle that the present inventors may appropriately define the concept of the terms to describe their invention in the best way. Therefore, the embodiments described in this specification and the configurations illustrated in the drawings are only some of the most preferred embodiments of the disclosure and do not represent all of the technical ideas of the disclosure, and it should be understood that there may be various equivalents and modified examples that can replace them at the time of filing this application.

As used herein, "comprise, include" and/or "comprising, including" specify mentioned shapes, numbers, steps, operations, members, components, and/or presence of these groups, and do not exclude the presence or addition of one or more different shapes, numbers, operations, members, components, and /or groups.

To help understanding of the present disclosure, the accompanying drawings are not shown according to the actual scale, and the dimensions of some components may be exaggerated. The same reference numerals may be given to the same components in different embodiments.

The statement that two comparison targets are 'the same' as each other may mean that they are 'substantially the same' as each other. Thus, a case where they are 'substantially the same' as each other may include a case where they have a deviation regarded as a low level, e.g., a deviation of 5 % or less. In case that a uniform parameter is uniform in a predetermined area, it may mean that it is uniform from an average point of view.

Although first, second, etc., may be used to describe various components, these components are not limited by these terms. These terms are only used to distinguish one component from other components, and unless specifically stated to the contrary, a first component may be a second component.

Throughout the specification, unless specially stated to the contrary, each component may be singular or plural.

When a component is arranged on "a top portion (or a bottom portion)" of another component or "on (or under)" the other component, it may mean not only a case where the component is arranged adjacent to a top surface (or a bottom surface) of the other component, but also a case where another component may be interposed between the other component and the component arranged on (or under) the other component.

When a component is described as being "connected", "coupled", or "connected" to another component, it should be understood that the components are directly connected or connectable to each other, but another component may be "interposed" between the components, or the components may be may be "connected", "coupled", or "connected" to each other through another component. In case that a portion is electrically coupled to another portion, this may include not only a case where they are directly connected to each other, but also a case where they are connected with another element therebetween.

Throughout the specification, "A and/or B" may mean A, B, or A and B unless specially stated otherwise. That is, "and/or" may include all or any combination of a plurality of items listed. "C to D" may mean at least C but not more than D, unless specially stated otherwise.

The terminology used herein is for the purpose of describing embodiments of the present disclosure and is not intended to be limiting of the present disclosure.

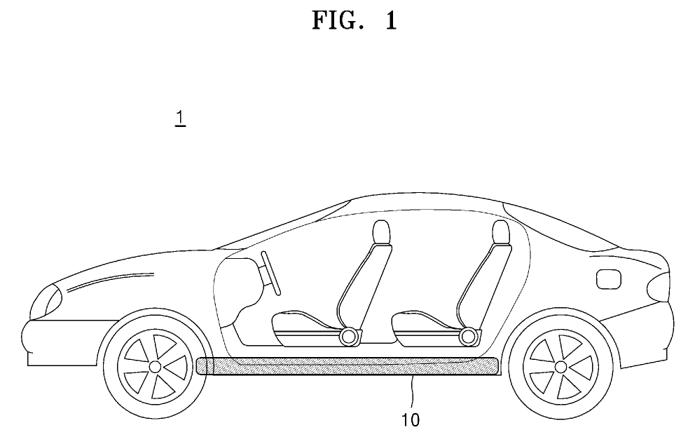

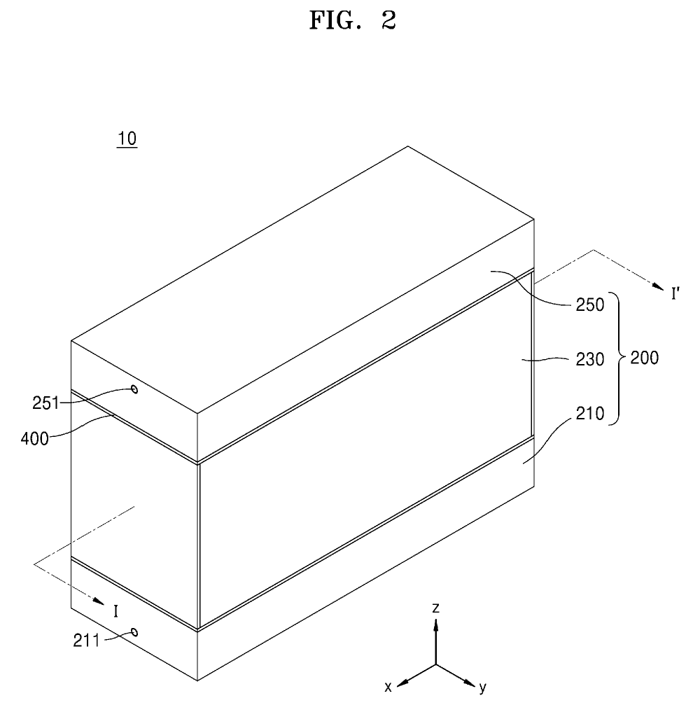

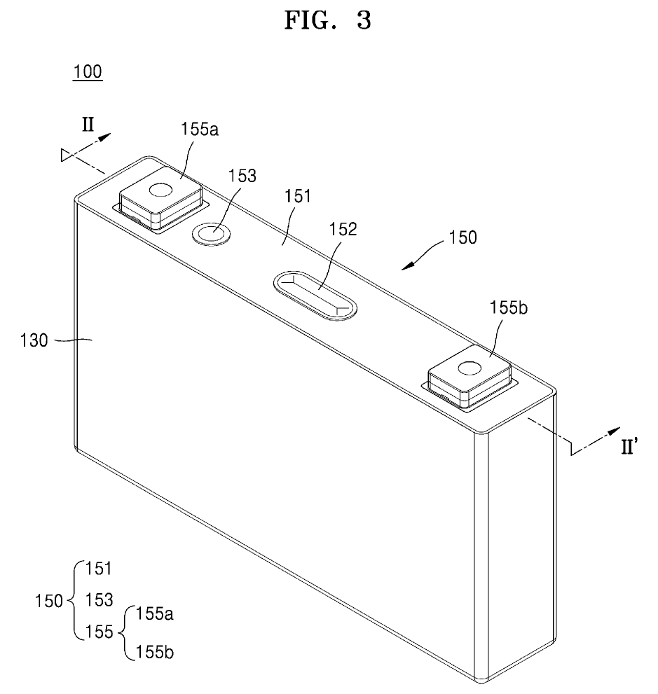

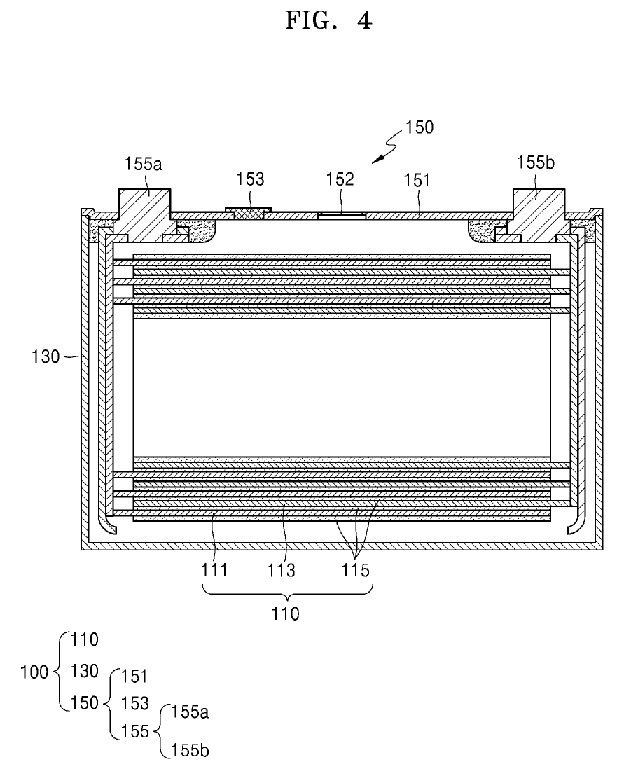

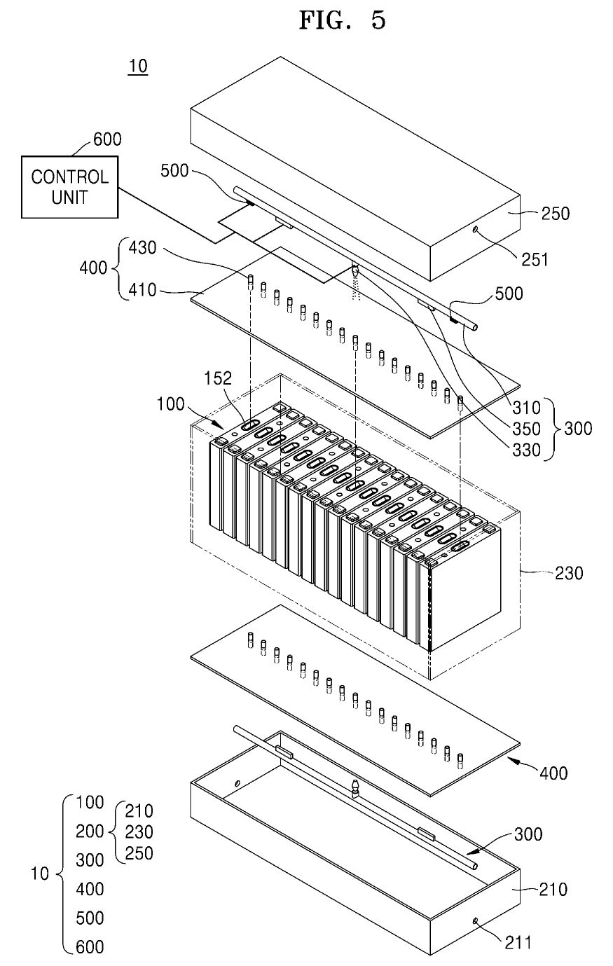

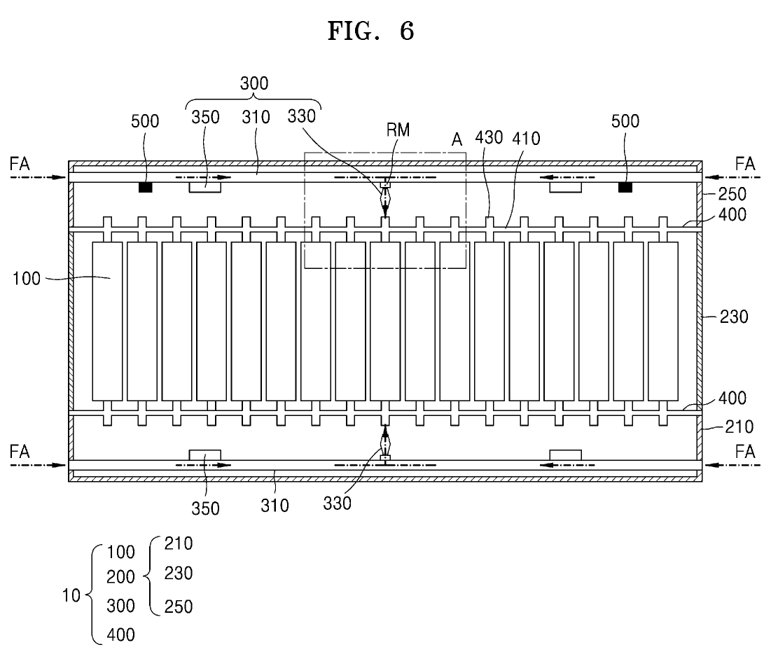

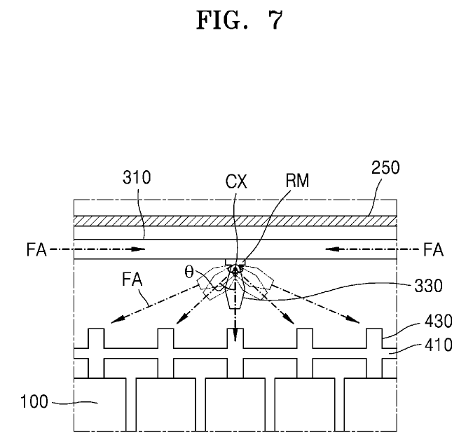

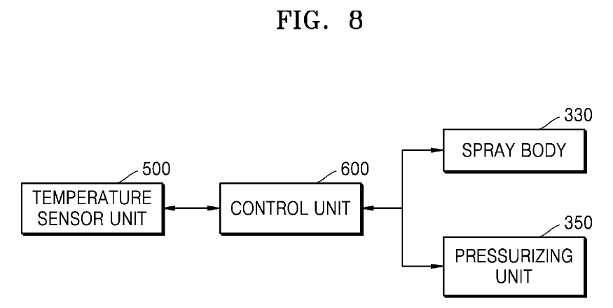

FIG. 1 is a perspective view of a vehicle including a battery pack according to an embodiment of the disclosure. FIG. 2 is a perspective view of a battery pack according to an embodiment of the disclosure. FIG. 3 is a perspective view of a battery cell according to an embodiment of the disclosure. FIG. 4 is a cross-sectional view of the battery cell of FIG. 3 along a line II-II'. FIG. 5 is an exploded perspective view of a battery pack according to an embodiment of the disclosure. FIG. 6 is a cross-sectional view of the battery pack of FIG. 2 along a line I-I'. FIG. 7 is an enlarged view of a portion A of FIG. 6. FIG. 8 is a block diagram of a control unit according to an embodiment of the disclosure.

Referring to FIG. 1, vehicle 1 may require a large amount of power. Specific examples of vechicles and other systems that require a large amount of power include an electric vehicle, an electric bus, a hybrid vehicle, an energy storage system (ESS), an electric propulsion ship, etc.

The vehicle 1 may be provided with a battery pack 10. In particular, the vehicle 1 may be electrically connected to the battery pack 10 to receive electric energy and use the battery pack 10 as a power source.

Referring to FIGS. 2 - 7, the battery pack 10 may include a plurality of battery cells 100 and may be mounted in, for example, an electric vehicle. More specifically, the battery pack 10 may include the battery cells 100, a pack housing 200, a spraying unit 300, a guiding unit 400, a temperature sensor unit 500, and a control unit 600.

In the battery pack 10, the plurality of battery cells 100 may mounted in the pack housing 200, and the battery pack 10 may be configured such that the positions of the battery cells 100 are fixed by an internal structure of the pack housing 200 without a separate structure confining the battery cells 100, like a module. Such a configuration may simplify the structure of the battery pack 10, improve space efficiency, and reduce production costs.

When thermal runaway occurs in one of the battery cells 100, the battery pack 10 according to an embodiment of the disclosure may spray a fire extinguishing agent FA toward a battery cell. This may quickly suppress a fire in the early stage. After the fire is suppressed, the battery cell in which the fire occurs may be easily replaced, thereby reducing the costs associated with fire response. Herein, the fire extinguishing agent FA may be sprayed from the spraying unit 300 inside the battery pack 10 to suppress a fire when thermal runaway occurs in one of the battery cells 100.

The fire extinguishing agent FA may be a substance used to suppress or stop a burning substance or combustion reaction. For example, the fire extinguishing agent FA may be a fluorinated fire extinguishing agent based on carbon-fluorine compounds (C-F bonds). When the fire extinguishing agent FA is a fluorine-based fire extinguishing agent, the fire extinguishing agent FA may be stored in a liquid state and may be sprayed toward the battery cell 100 and then spread as a gas. As a result, after fire suppression, the sprayed fire extinguishing agent does not remain inside the battery pack 10, thereby preventing damage to the other battery cells 100. However, the disclosure is not limited to, and the fire extinguishing agent FA according to embodiments of the present disclosure may be transformed into various fire extinguishing agents such as water mist, aqueous vermiculite dispersion (AVD), inert gas fire extinguishing agents, etc., within the technical spirit of the fire extinguishing agent FA being sprayed to the battery cell 100 to prevent temperature rise and suppress a fire. The fire extinguishing agent FA may be a substance in various states such as a fluid type, a powder type, a gel type, etc.

Referring to FIGS. 5 - 7, the plurality of battery cells 100 may be provided, may be arranged in a preset direction. The battery cells 100 may be physically and electrically connected to one another.

Herein, a 'battery cell assembly' will be defined as the plurality of battery cells 100 connected in series or parallel and arranged in a direction such that wide surfaces of adjacent battery cells 100 face each other. A spacer (not shown in the drawings) may be arranged between adjacent battery cells 100 of the battery cell assembly. In the event that an external shock or vibration occurs, the spacer may maintain a space between the battery cells 100 to prevent the battery cells 100 from directly contacting each other.

The spacer may be formed of an insulating material and, in case that thermal runaway occurs due to heat generated in charging/discharging of the battery cell 100, the spacer may prevent the heat from being transferred between adjacent battery cells 100. However, the disclosure is not limited thereto, and the spacer may be formed of a material having an elastic restoring force, such as polyurethane foam, rubber, silicone, etc., to absorb deformation when the battery cell 100 expands, or may be transformed into various materials depending on the characteristics of the battery pack 10 and the type of system in which the battery pack 10 is mounted. For example, the spacer may be formed of a thermally conductive material to quickly release heat generated from the battery cell 100 to outside.

According to an embodiment, the battery pack 10 may include a plurality of battery cell assemblies. The plurality of battery cell assemblies may be arranged parallel to one another. The battery cell assemblies may be arranged in a width direction (a y-axis direction shown in FIG. 2) of the pack housing 200. This configuration may expand a voltage and a capacity with the battery cells 100 and improve the structural stability and performance of the battery cells 100.

Referring to FIGS. 3 - 5, the battery cell 100 may be a rechargeable battery and may include an electrode assembly 110, a case 130, and a cap plate assembly 150.

The electrode assembly 110 according to an embodiment of the disclosure may include a positive electrode 111 and a negative electrode 113. In some embodiments, a separator 115, which is an insulator, may be inserted between the positive electrode 111 and the negative electrode 113 and then the electrode assembly 110 may be formed by winding the electrodes 111 and 113 and the separator 115. However, the disclosure is not limited thereto. In other embodiments, the electrode assembly 110 may be such that the positive electrode 111 and the negative electrode 113 are sheets that are alternately stacked with the separator 115 therebetween.

The battery cell 100 according to an embodiment will be described as a prismatic-type lithium ion secondary battery. However, the disclosure is not limited thereto, and the disclosure includes various types of battery cells, such as a lithium polymer battery cell or a cylindrical battery cell.

Referring to FIG. 4, the positive electrode 111 and the negative electrode 113 may include coated portions where an active material is applied to a current collector formed of a metal foil of a thin plate. The electrodes 111 and 113 may also include non-coated portions where the active material is not provided.

The case 130 according to an embodiment of the disclosure may accommodate the electrode assembly 110 therein, form the overall exterior of the battery cell 100, and may be formed of a conductive metal such as aluminum, an aluminum alloy, or nickel-plated steel. The case 130 may provide a space in which the electrode assembly 110 is accommodated.

The case 130 according to an embodiment is illustrated as a cuboid with one side open, but the disclosure is not limited thereto and may be variously modified into a cylindrical shape, a prismatic shape, etc.

The case 130 according to an embodiment of the disclosure may have an inner space in which the electrode assembly 110 is accommodated along with an electrolyte. A side of the case 130 may be open. The electrode assembly 110 may be inserted into the case 130 through the open side of the case 130.

Referring to FIGS. 3 - 5, the cap plate assembly 150 may cover the open side and be coupled to the case 130. The cap plate assembly may include a cap plate 151, an inlet stopper 153, and an electrode terminal 155.

The cap plate 151 may be formed in a thin plate shape and may be welded to the case 130. The cap plate 151 may protect a surface of the battery cell 100, prevent physical damage to the battery cell 100, and block substances outside the battery cell 100 from flowing into the case 130. The cap plate 151 may also seal the case 130 to prevent the electrolyte inside the case 130 from leaking out.

A vent 152 may be formed in the cap plate 151. The vent 152 may be a region that is configured to rupture when the internal pressure of the case 130 increases or thermal runaway occurs. As such, gas inside the case 130 may be discharged to outside of the battery cell 100 through the ruptured vent 152. Thus, the battery cell 100 may be made safe as risks due to overcharging and overheating are reduced.

Referring to FIGS. 3 - 5, the vent 152 may be formed in the central portion of the cap plate 151. In other words, the vent 152 may be arranged between the electrode terminals 155a and 155b that are arranged at opposite ends of the cap plate 151.

An inlet hole may be formed in the cap plate 151 to allow the electrolyte to be injected into the case 130. The inlet hole may also function as a passage through which the electrolyte is replenished or replaced during maintenance of the battery cell 100. The inlet stopper 153 that seals the inlet hole may be inserted into the inlet hole.

Referring to FIGS. 3 and 4, the inlet hole may be arranged on a side of the vent 152 and between the electrode terminals 155a and 155b. However, the disclosure is not limited thereto, and various other arrangements are possible. For example, the inlet hole may be arranged on an outside of the electrode terminals 155a and 155b and away from the vent 152.

Referring to FIGS. 3 and FIG. 4, the electrode terminal 155 may be electrically connected to the positive electrode 111 or the negative electrode 113. The electrode terminal 155 may protrude outwardly through the cap plate 151. A plurality of electrode terminals 155 may be provided in the length direction of the cap plate 151, and the plurality of electrode terminals 155 may include the positive terminal 155a and the negative terminal 155b. Outer circumferential surfaces of upper pillars of the positive terminal 155a and the negative terminal 155b protruding outwardly from the cap plate 151 may be threaded and fixed onto the cap plate 151 with a nut. However, the disclosure is not limited thereto, and the positive terminal 155a and the negative terminal 155b may be variously configured, such as being riveted with a rivet structure or welded to the cap plate 151.

Referring to FIGS. 5 - 7, the pack housing 200 may have an inner space in which the plurality of battery cells 100 are accommodated. The pack housing 200 may form the exterior of the battery pack 10 and protect the battery cell assembly from an external shock, vibration, dust, moisture, etc. The pack housing 200 stably fix the battery cell assembly such that the battery cells 100 maintain their positions.

The pack housing 200 may be formed of various materials. For example, the pack housing 200 may be formed of a metal material such as aluminum, steel, a nickel-plated steel plate, etc. However, the disclosure is not limited to these examples, and the pack housing 200 may be formed from various materials that provide electrical insulation and strong durability. Further examples include plastic materials such as polycarbonate, polypropylene, etc.

The pack housing 200 according to an embodiment of the disclosure may include a base 210, a side wall 230, and a cover 250.

Referring to FIGS. 2, 5, and 6, the base 210 may be arranged at the bottom (as shown in FIG. 5) of the pack housing 200 and may support the plurality of battery cells 100, the guiding unit 400, and the spraying unit 300.

A connecting hole 211 that is connected to the spraying unit 300 may be formed on opposite sides of the base 210 (left and right sides based in FIG. 5). The connecting hole 211 may form a passage between the outside of the battery pack 10 and the spraying unit 300. Thus, the fire extinguishing agent FA supplied from outside may flow to the inside of the spraying unit 300 through the connecting hole 211. An outlet may also be formed in the base 210 to discharge the sprayed fire extinguishing agent FA to outside of the battery pack 10.

Referring to FIGS. 2, 5, and 6, the side wall 230 may be connected to the base 210, may be configured to surround the battery cell assembly. The side wall 230 may define an inner space in which the battery cell assembly is accommodated. A surface (a bottom surface based on FIG. 5) of the side wall 230 facing the base 210 be shaped to correspond to the base 210 when the base 210 has a rectangular shape, the side wall 230 may be cuboid shaped with and open top and bottom. The side wall 230 may cover the side surfaces of the plurality of battery cells 100 that do not face one another and the opposite ends of the battery cell assembly.

Referring to FIG. 5, the cover 250 may be arranged opposite to the base 210 and cover the battery cell assembly, thereby protecting the battery cell assembly from an external environment and contaminants. The cover 250 may have a shape corresponding to the shape of the base 210. That is, the cover 250 may be arranged on a side (a top side in FIG. 5) of the side wall 230 having a rectangular cross-section, and the base 210 may be arranged on the other side (a bottom side in FIG. 5) of the side wall 230, thereby forming a cuboid shape.

The connecting hole 251 that may be connected to the spraying unit 300 and may be formed on opposite sides of the cover 250 (left and right sides in FIG. 5). As described above, the connecting hole 251 may connect the outside of the battery pack 10 and the spraying unit 300, and the fire extinguishing agent FA supplied from the outside may flow to the inside of the spraying unit 300 through the connecting hole 251.

Referring to FIGS. 5 - 7, the spraying unit 300 may be arranged inside the pack housing 200. The spraying unit 300 may adjust a spraying path to spray the fire extinguishing agent FA toward any one of the battery cells 100. The spraying unit 300 may include a flow tube 310, a spray body 330, a pressurizing unit 350, and a rotating member RM. When a thermal runaway occurs in a specific battery cell among the battery cells 100, the spraying unit 300 may detect a temperature rise in the battery cell 100 and spray the fire extinguishing agent FA toward the specific battery cell 100. Hereinafter, the battery cell 100 that has undergone thermal runaway and thus is a spraying target of the fire extinguishing agent FA will be referred to as a 'target cell'.

The spraying unit 300 may spray the fire extinguishing agent FA to the target cell simply after detecting a temperature rise, for example, when a short circuit occurs inside the battery cell 100 or thermal runaway occurs inside the battery cell 100 due to external shock and pressure. This may prevent the fire from spreading to adjacent battery cells 100 and enable early suppression of the fire. After fire suppression, only the target cell may need to be replaced and the battery pack 10 may be used again, thereby reducing costs.

A plurality of spraying units 300 may be provided. The spraying units 300 may be spaced apart from each other to face each other with the battery cells 100 therebetween. In other words, the spraying units 300 may be arranged on a side of the battery cell assembly where the plurality of vents 152 are arranged (a bottom side in FIG. 5) and on an opposite side of the battery cell assembly (a bottom side in FIG. 5). The spraying units 300 may have the same configuration and be arranged symmetrically.

Hereinafter, a description will be made based on the spraying unit 300 arranged at the top side of the battery cell assembly. But the descriptions of the spraying unit 300 apply to the spraying unit 300 arranged at the bottom side.

Referring to FIGS. 5 - 7, the flow tube 310 may be hollow inside, may allow the fire extinguishing agent FA to flow therethrough, and may extend along a direction in which the plurality of battery cells 100 are arranged. The flow tube 310 may be arranged parallel to a straight line connecting the widthwise centers of the battery cells 100. In other words, the flow tube 310 may be arranged parallel to a straight line connecting the vents 152 of the battery cells 100.

The flow tube 310 according to an embodiment of the disclosure may be formed in the shape of an extended pipe extending. When a fire occurs and the fire extinguishing agent FA flows inside the flow tube 310 in a pipe shape, the fire extinguishing agent FA may be sprayed by the spray body 330 and discharged toward the target cell.

In a normal state where a temperature of the battery cell 100 is not elevated, the fire extinguishing agent FA may be stored in a separate storage tank arranged outside or inside the pack housing 200. The fire extinguishing agent FA may be supplied to the inside of the flow path 310 through the connecting holes 211 and 251 upon detection of a temperature rise of the battery cell 100. However, the disclosure is not limited in this regard, and in the normal state, the fire extinguishing agent FA may accumulate inside the flow path 310.

Referring to FIGS. 5 - 7, the spray body 330 may be in fluid communication with the flow tube 310. The spray body 330 may be arranged at the longitudinal center of the flow tube 310 to spray the fire extinguishing agent FA toward the battery cell 100. The spray body 330 may spray the fire extinguishing agent FA supplied through the flow tube 310 to the battery cell 100 upon detection of the temperature rise of the specific battery cell 100.

Referring to FIG. 7, the spray body 330 may be rotatably connected to the flow the 310 and may adjust the spraying path. The rotating member RM may be arranged on a side of the spray body 330. The rotating member RM may be connected to the spray body 330 and may provide a driving force to rotate the spray body 330 relative to the flow tube 310.

A rotational center axis CX of the spray body 330 may be arranged at an end of the spray body 330 connected to the rotating member RM. The spray body 330 may receive a driving force from the rotating member RM and rotate around the rotational center axis CX that is set with respect to the flow tube 310.

An end of the spray body 330 opposite to the end of the spray body 330 at the rotational center axis CX may spray the fire extinguishing agent FA toward the target cell. That is, an end of the spray body 330 may be connected to the flow tube 310 such that the fire extinguishing agent FA may be introduced into the spray body 330, and a plurality of spraying holes may be formed at the opposite end of the spray body 330 to spray the fire extinguishing agent FA.

The direction of the spray body 330 may be adjusted by rotating the spray body 330 about the rotational center axis CX such that the spraying end faces the target cell, and then the spray body 330 may spray the fire extinguishing agent FA toward the target cell. Thus, the fire extinguishing agent FA may be sprayed directly to the target cell where thermal runaway occurs.

Referring to FIG. 7, the spray body 330 may receive the driving force from the rotating member RM and rotate to a preset angle with respect to the flow path 310. Hereinafter, the position of the spray body 330 will be defined as a reference position when a side of the spray body 330 is directed toward the battery cell 100 arranged directly under the spray body 330 (as shown in FIG. 7), in other words, when an angle formed by the axial length of the spray body 330 and the flow path 310 is a right angle. An angle formed by a straight line connecting opposite ends of the spray body 330 at the reference position and a straight line connecting opposite ends of the spray body 330 after rotation from the reference position is defined as a rotation angle θ of the spray body 330.

The rotation angle θ may increase as the target cell is arranged farther away from the spray body 330. In some embodiments, when the spray body 330 faces a battery cell arranged in the center of the battery cell assembly (hereinafter, referred to as a center cell), the rotation angle θ may be 0°. The rotation angle θ may increase by a specific angle (hereinafter referred to as a unit angle) as the target cell moves away from the battery cell arranged at the center of the battery cell assembly by a certain distance.

In some embodiments, the rotation angle θ may increase by a constant angle each time the number of battery cells 100 arranged between the center cell and the target cell increases by one. In a specific embodiment, the unit angle may be 4°. Thus, when the spray body 330 is directed toward a cell arranged immediately next to the center cell, the rotation angle θ may be 4°, and when the spray body 330 is directed toward the next cell (when there is one battery cell between the center cell and the target cell), the rotation angle θ may be 8°. As such, each time when the number of cells arranged between the center cell and the target cell increases by one, the rotation angle θ may also increase by a unit angle.

The unit angle may be various angles depending on the thickness of the battery cell, a spacing between the battery cells, and the number of battery cells arranged in one battery pack 10. In some embodiments, the unit angle may vary depending on a distance between the target cell and the center cell.

The battery cell assembly may be divided into a plurality of regions based on a distance from the center cell. For example, an internal region of the pack housing 200 may be divided into three regions in the length direction of the battery cell assembly. The three regions may include a first region including the center cell, a second region arranged to the left of the first region, and a third region arranged to the right of the first region. The unit angle may be set to a relatively large angle in the first region including the center cell, and to a relatively small angle in the second and third regions that are relatively far from the center cell. In a specific example, the unit angle in the first region may be 10°, and the unit angles in the second and third regions may be 4°. As the number of cells arranged between the center cell and the target cell increases by one, the rotation angle θ in the first region may increase by 10°, and the rotation angles θ in the second and third regions may increase by 4°. That is, the rotation angle θ may increase by a preset unit angle as the distance between the target cell and the center cell increases, and the unit angle may be set based on a region where the target cell is arranged, for example, may be set to be relatively large in a region close to the center cell and relatively small in a region far from the center cell. As a result, even in case that the target cell is arranged far from the spray body 330, the spray body 330 may spray the fire extinguishing agent FA directly at the target cell.

A plurality of spray bodies 330 may be provided and arranged spaced apart from one another in the length direction of the flow tube 310. In some embodiments, the internal region of the pack housing 200 may be divided into three regions in the length direction of the battery cell assembly. The three regions may include a first region including the center cell, a second region arranged to the left of the first region, and a third region arranged to the right of the first region.

The spray body 330 may be arranged on top and bottom sides of each of the three divided regions (as shown in FIG. 6). A total of six spray bodies 330 may be provided. As such, when the plurality of spray bodies 330 are provided, the number of battery cells 100 covered by one spray body 330 is reduced, and the rotation angle θ of each spray body 330 may be controlled such that the spray body 330 may rotate only within a corresponding region range. As a result, one spray body 330 may be set to respond to a narrower range of battery cells 100, thereby enabling a rapid local response in the event of thermal runaway. Further, the fire extinguishing agent FA may be sprayed more intensively and without loss, such that the fire extinguishing effect may be concentrated and the fire extinguishing agent FA may be sprayed precisely to the target cell, thereby preventing unnecessary waste of the fire extinguishing agent FA.

Referring to FIGS. 5 - 7, the pressurizing unit 350 may be connected to the flow tube 310 and may provide pressure to the fire extinguishing agent FA flowing in the flow tube 310. When the spray body 330 sprays the fire extinguishing agent FA to the target cell, the fire extinguishing agent FA must flow to a region of the flow tube 310 to which the spray body 330 is connected, for example, toward the center of the flow tube 310. The pressurizing unit 350 may apply pressure to the fire extinguishing agent FA such that the fire extinguishing agent FA flows toward the center of the flow path 310.

The pressurizing unit 350 may be, for example, an air pump that sprays a compressed gas to move the fire extinguishing agent FA in a desired direction. However, the disclosure is not limited thereto, and the pressurizing unit 350 may be various pumps that can apply a force to the fire extinguishing agent FA to cause the fire extinguishing agent FA to flow in a specific direction, such as a piston pump, a diaphragm pump, etc. That is, the pressurizing unit 350 may apply pressure to the fire extinguishing agent FA to supply a sufficient amount of the fire extinguishing agent FA to the spray body 330 when the fire extinguishing agent FA is accumulated at a specific position of the flow tube 310 or the fire extinguishing agent FA is not sufficiently supplied to the spray body 330.

A plurality of pressurizing units 350 may be provided and arranged on opposite sides of the flow tube 310. The pressurizing unit 12 may simultaneously apply pressure toward the center from the opposite sides of the flow path 310 (left and right as depicted in FIG. 6) such that the fire extinguishing agent FA may be exactly sprayed through the spray body 330. In some embodiments, the pressure applied by each of the pressurizing units 350 may be adjusted to cause the fire extinguishing agent FA accumulated at a specific position of the flow tube 310 to flow toward the center of the flow tube 310, and as the pressure applied from the opposite sides is adjusted, the position of the fire extinguishing agent FA may be precisely adjusted to the center of the flow path 310.

The spraying unit 300 may further include a flow rate sensor unit installed on a side of the flow path 310. The flow rate sensor unit may measure a flow rate of the fire extinguishing agent FA flowing inside the flow tube 310. The flow rate sensor may be an electronic flow rate sensor unit such as an electromagnetic sensor, a thermal sensor, an ultrasonic sensor, etc., or a mechanical flow rate sensor unit such as a piston-type sensor, etc. The flow rate sensor unit may transmit a value of the measured flow rate of the fire extinguishing agent FA to the control unit 600. The operation of the pressurizing unit 350 may be controlled by the measured flow rate of the fire extinguishing agent FA such that an appropriate amount of the fire extinguishing agent FA is supplied to the spray body 330.

The flow rate sensor unit may be arranged in the flow tube 310. Thus, the fire extinguishing agent FA flowing in the flow tube 310 may directly pass through the flow rate sensor unit, and the flow rate of the fire extinguishing agent FA may be precisely measured. However, the disclosure is not limited thereto, and the flow rate sensor unit may be positioned at the outer side of the flow tube 310 to indirectly measure the flow rate of the fire extinguishing agent FA.

A plurality of flow rate sensor units may be provided and arranged on opposite sides of the flow tube 310. Thus, the flow rates of the fire extinguishing agent FA flowing on opposite sides of the flow tube 310 may be measured simultaneously, and the control unit 600 may receive about the measured values of the flow rates on the opposite sides of the flow tube 310 to precisely control the operation of the pressurizing unit 350.

The flow rate sensor unit may be positioned adjacent to the center of the flow tube 310 to which the spray body 330 is connected. The flow rate sensor unit may measure the flow rate of the fire extinguishing agent FA sprayed into the pack housing 200 through the spray body 330 in real time, and the control unit 600 may adjust the amount of the fire extinguishing agent FA sprayed using the value of the flow rate. This may prevent an excessive amount of fire extinguishing agent FA from being sprayed and the fire extinguishing agent FA being wasted.

Referring to FIGS. 5 - 7, the guiding unit 400 may be arranged between the spraying unit 300 and the battery cells 100 and may guide the flow of the fire extinguishing agent FA sprayed from the spraying unit 300 to the battery cells 100. Such guiding units 400 may be provided and arranged on opposite sides of the plurality of battery cells 100. In other words, a first guiding unit 400 may be arranged on the side of the battery cell assembly where the plurality of vents 152 are arranged (the top side in FIG. 5) and a second guiding unit 400 may be arrange on another side of the battery cell assembly (the bottom side in FIG. 5). Each of the guiding units 400 may have the same configuration and the guiding units 400 may be arranged symmetrically.

Hereinafter, a guiding unit 400 arranged on the top side of the battery cell assembly will be described. But the descriptions of the guiding unit 400 arranged on the top side may equally apply to the guiding unit 400 arranged on the bottom side.

The guiding unit 400 according to an embodiment of the disclosure may include a guide plate 410 and a guide body 430. Referring to FIG. 5, the guide plate 410 may cover the outer side of the plurality of battery cells 100 and may be rectangular plate shaped. In some embodiments, the guide plate 410 may have a shape corresponding to a surface of the cover 250 and may cover a surface (a top surface as shown in FIG. 5) of the battery cell assembly. However, the present disclosure is not limited thereto, and the guide plate 410 may be formed to cover a part of the battery cell assembly, and may be various shapes configured to guide the flow of the fire extinguishing agent FA sprayed from the spraying unit 300.

Referring to FIGS. 5 - 7, the guide body 430 may be connected to the guide plate 410, may be hollow, and may allow the fire extinguishing agent FA to pass therethrough. In some embodiments, the guide body 430 form fluid communication between a space surrounded by the cover 250 and the guide plate 410 (an upper space of the guiding unit as depicted in FIG. 6) and a space between the battery cell assembly and the guide plate 410 (a lower space of the guiding unit as depicted FIG. 6). The guide body 430 may be in the shape of a pipe extending in the longitudinal direction (a top-bottom direction in FIG. 6) and opposite ends that are both open.

The fire extinguishing agent FA sprayed from the spray body 330 may flow to an open side of the guide body 430 and may be discharged from the opposite open side of the guide body 430 to to contact the target cell. The fire extinguishing agent FA may be accurately guided by the guide body 430 to the target cell.

In some embodiments, a plurality of guide bodies 430 may be provided, with the number of guide bodies 430 corresponding to the number of battery cells 100. The guide body 430 may be arranged along the longitudinal direction of the battery cell assembly, that is, along the direction in which the plurality of battery cells are arranged. In some embodiments, the plurality of guide bodies 430 may face the vents 152 of the respective corresponding battery cells 100. Thus, the fire extinguishing agent FA passing through the guide body 430 may be guided to the vent 152 located on a surface of the target battery cell 100. As the vent 152 is opened due to thermal runaway of the battery cell 100, the fire extinguishing agent FA may immediately flow into the inner side of the battery cell 100 through the vent 152 to lower the temperature of the battery cell 100 and extinguish the fire.

In some embodiments, the plurality of guide bodies 430 may be formed integrally with the guide plate 410.

Referring to FIG. 8, the temperature sensor unit 500 capable of detecting the temperature of the plurality of battery cells 100 may be arranged inside the pack housing 200. The temperature sensor unit 500 may detect a temperature rise in any one of the battery cells 100 and transmit an electrical signal to the control unit 600. The temperature sensor unit 500 may include an infrared temperature sensor that detects infrared energy, such as a thermal imaging camera, and measures a temperature of the target. The temperature sensor unit 500 may detect the position of the battery cell 100 with the temperature rise, i.e., the target cell. As a result, the temperature sensor unit 500 may transmit specific temperature information and position information of the detected target cell to the control unit 600.

A plurality of temperature sensor units 500 may be provided, with the temperature sensor unit 500 being arranged on upper and lower portions (as shown in FIG. 6) of the battery cell assembly. The temperature sensor unit 500 may be arranged at the center of the base 210 and the center of the cover 250 to simultaneously measure the temperatures of the upper and lower portions of each battery cell 100.

The temperature sensor unit 500 may be arranged on opposite sides of the base 210 and the cover 250. However, the position of the temperature sensor unit 500 is not limited thereto in the present disclosure, and the temperature sensor unit 500 may be arranged in various positions inside the pack housing 200 so as to measure the temperatures and positions of the battery cells 100.

Referring to FIG. 8, the control unit 600 may be electrically connected to the spraying unit 300 and may control the spraying of the fire extinguishing agent FA. The control unit 600 may receive temperature information and position information of the target cell from the temperature sensor unit 500 and control the operations of the rotating member RM, the spray body 330, and the pressurizing unit 350.

In some embodiments, the control unit 600 may be electrically connected to the temperature sensor unit 500. When the temperature any one of the battery cells 100 rises above a preset value as detected by the temperature sensor unit 500, the control unit 600 receiving the temperature information may set the corresponding battery cell 100 as the target cell. Specifically, the control unit 600 may be electrically connected to the rotating member RM and may adjust the rotation angle θ of the spray body 330 such that the spraying end of the spray body 330 faces the target cell, particularly, the open side of the guide body 430 arranged to correspond to the target cell.

The control unit 600 may be electrically connected to the pressurizing unit 350 and may control the operation of the pressurizing unit 350 to provide a pressure that causes the fire extinguishing agent FA to flow toward the center of the flow tube 310, i.e., toward the spray body 330 when the spray body 330 is directed to the correct position. The operation of the spray body 330 may be controlled such that an accurate amount of fire extinguishing agent FA may be sprayed to the target cell.

Operating principles and effects of the battery pack 10 according to an embodiment of the disclosure will now be described.

Referring to FIGS. 2 - 8, the battery pack 10 may include the battery cell 100, the pack housing 200, the spraying unit 300, the guiding unit 400, the temperature sensor unit 500, and the control unit 600.

The battery cells 100 are arranged inside the pack housing 200, and a plurality of battery cells 100 may be arranged in a row to form the battery cell assembly. The spraying units 300 may be arranged on the top and bottom sides of the battery cell assembly.

The spraying unit 300 may include the flow tube 310, the spray body 330, and the pressurizing unit 350. The spraying unit 300 may spray the fire extinguishing agent FA to the specific battery cell 100 with the temperature rise, i.e. the target cell.

The temperature sensor unit 500 may transmit the temperature information and the position information of each of the battery cells 100 to the control unit 600. The flow rate sensor unit installed in the flow tube 310 may transmit the flow rate of the fire extinguishing agent FA to the control unit 600.

The control unit 600 may set the specific battery cell 100 as a target cell when the temperature of the battery cell 100 rises above a preset value. And the control unit 600 may adjust the operation of the spraying unit 300 to accurately spray the fire extinguishing agent FA to the target cell.

When the temperature rise of the specific battery cell 100 is detected by the temperature sensor unit 500, the external fire extinguishing agent FA may be supplied to the flow tube 310 through the connecting holes 211 and 251. The fire extinguishing agent FA may be simultaneously supplied from the opposite ends of the flow tube 310 connected to the connecting holes 211 and 251. The fire extinguishing agent FA supplied from the opposite ends may be sprayed toward the target cell through the spray body 330 at the center of the flow tube 310. In some embodiments, the fire extinguishing agent FA may be supplied to a side of the flow tube 310 and then sprayed through the spray body 330 at the center of the flow tube 310. The remaining fire extinguishing agent FA that is not sprayed may be discharged through another side of the flow tube 310.

The control unit 600 may be electrically connected to the rotating member RM and may adjust the rotation angle θ of the spray body 330 to direct an end of the spray body 330 toward the target cell. When the center cell is the target cell, the rotation angle θ may be 0°. Each time the number of battery cells 100 arranged between the target cell and the center cell increases by one, the rotation angle θ may increase by a unit angle.

The battery cell assembly may be divided into a plurality of regions based on a distance from the center cell. The unit angle of the spray body 330 when the target cell is arranged in a region adjacent to the center cell may be different from the unit angle of the spray body 330 when the target cell is arranged in a region distant from the center cell. In some embodiments, the unit angle may decrease as the target cell is arranged in a region farther away from the center cell. When an end of the spray body 330 is rotated by the rotating member RM to a preset rotation angle θ toward the target cell, the pressurizing unit 350 may apply pressure to the fire extinguishing agent FA. The control unit 600 may control the operation of the pressurizing unit 350 such that the fire extinguishing agent FA flows in a preset direction and at a preset flow rate inside the flow tube 310.

In some embodiments, the control unit 600 may receive the flow rate of the fire extinguishing agent FA flowing inside the flow path 310 from the flow rate sensor unit and control the operation of the pressurizing unit 350 based on the value of the flow rate. The control unit 600 may control the operation of the pressurizing units 350 arranged at opposite sides of the flow path 310 such that the fire extinguishing agent FA of the flow path 310 does not move to one side due to pressure, but rather such that the fire extinguishing agent PA precisely flows to the center of the flow tube 310 where the spray body 330 is arranged. For example, the control unit 600 may control the operation of the pressurizing units 350 on opposite sides such that the same pressure is applied toward the center of the flow tube 310 where the spray body 330 is arranged. The control unit 600 may control the operation of the pressurizing unit 350 to apply pressure to the fire extinguishing agent FA introduced through a side of the flow path 310 and adjust the flow path of the fire extinguishing agent FA to allow the fire extinguishing agent FA to be discharged through the other side of the flow path 310. When the fire extinguishing agent FA remaining inside the flow path 310 is to be discharged after the injection of the fire extinguishing agent FA is completed, the control unit 600 can control the operation of one of the pressurizing units 350.

Referring to FIG. 5, to discharge the fire extinguishing agent FA inside the flow tube 310 through the connecting hole on the right side (as shown in FIG. 5), the control unit 600 may control the operation of the pressurizing unit 350 arranged on the left side. Upon supply of pressure for pushing the fire extinguishing agent FA to the right from the pressurizing unit 350 on the left side, the fire extinguishing agent FA may flow toward the right side and be discharged to outside of the battery pack 10. Thus, the control unit 600 may easily adjust the flow path, flow rate, speed, etc., of the fire extinguishing agent FA flowing into and out of the spraying unit 300 by individually controlling the operation of the pressurizing units 350 arranged on opposite sides of the flow tube 310.

When the fire extinguishing agent FA moves to the center of the flow tube 310 connected to the spray body 330, the control unit 600 may control the operation of the spray body 330 such that the fire extinguishing agent FA is sprayed toward the target cell through the spray body 330.

The control unit 600 may receive information on the flow rate of the fire extinguishing agent FA sprayed from the spray body 330 from a flow rate sensor unit positioned adjacent to the spray body 330. The control unit 600 may appropriately adjust the amount of fire extinguishing agent FA sprayed based on the flow rate information.

The fire extinguishing agent FA sprayed from the spraying unit 300 may have the flow that is guided through the guiding unit 400. In some embodiments, in case that the fire extinguishing agent FA is sprayed from the top side of the battery cell assembly, the fire extinguishing agent FA may pass through the guide body 430 directly to the vent 152 of the target cell. Thus, in case that the vent 152 is opened due to thermal runaway of the battery cell 100, the fire extinguishing agent FA may immediately flow into the battery cell 100 through the vent 152 to lower the temperature of the battery cell 100 and extinguish the fire.

The battery pack 10 according to an embodiment of the disclosure may immediately spray the fire extinguishing agent FA to the battery cell 100 by detecting the temperature rise in the event of thermal runaway in the battery cell 100. Thus, a large-scale fire can be prevented. And as the fire extinguishing agent FA may be sprayed on the battery cell 100 where the fire has occurred, the replacement cost may be reduced as only the targeted battery cell 100 may need to be replaced thereafter.

The effects obtainable through the disclosure are not limited to the effects described above, and other technical effects not mentioned will be clearly understood by those skilled in the art from the disclosure.

While the disclosure is described with reference to specific embodiments, the disclosure is not limited to those embodiments. Various modifications and changes may be made by those of ordinary skill in the art within the technical spirit of the disclosure.

What is claimed is:

1. A battery pack comprising:
a pack housing
a plurality of battery cells accommodated in the pack housing;
a spraying unit including a flow tube arranged inside the pack housing, the spraying unit being configured to adjust a spraying path to cause a fire extinguishing agent to be sprayed toward any one of the battery cells.

2. The battery pack of claim 1, wherein the spraying unit is provided as a plurality of spraying units, and
wherein the spraying units are spaced apart with the battery cells between the spraying units.

3. The battery pack of claim 1, wherein the flow tube is hollow inside such that the fire extinguishing agent flows through the flow tube, and
wherein a spray body is connected to the flow tube and is configured to spray the fire extinguishing agent toward the battery cells.

4. The battery pack of claim 3, wherein the spray body is rotatably connected to the flow tube and is capable of adjusting the spraying path of the fire extinguishing agent.

5. The battery pack of claim 4, wherein the spraying unit further comprises a pressurizing unit that is connected to the flow tube and is configured to supply pressure to the fire extinguishing agent flowing in the flow tube.

6. The battery pack of claim 1, further comprising a guiding unit arranged between the spraying unit and the battery cells, the guiding unit being configured to guide the fire extinguishing agent sprayed from the spraying unit to the battery cells.

7. The battery pack of claim 6, wherein the guiding unit comprises:
a guide plate covering an outer side of the plurality of battery cells; and
a guide body connected to the guide plate and configured to allow the fire extinguishing agent to pass therethrough.

8. The battery pack of claim 7, wherein the guide body is provided as a plurality of guide bodies each of which corresponds to one of the battery cells.

9. The battery pack of claim 1, further comprising a temperature sensor unit arranged inside the pack housing and configured to detect a temperature of the battery cells.

10. The battery pack of claim 1, further comprising a control unit electrically connected to the spraying unit and configured to control the spraying path of the fire extinguishing agent.

11. An electric product comprising a battery pack configured to supply power,
wherein the battery pack comprises:
a pack housing;
a plurality of battery cells accommodated in the pack housing; and
a spraying unit including a flow tube arranged inside the pack housing, the spraying unit being configured to adjust a spraying path to cause a fire extinguishing agent to be sprayed toward any one of the battery cells.

12. The electric product of claim 11, wherein the spraying unit is provided as a plurality of spraying units, and
wherein the spraying units are spaced apart with the battery cells between the spraying units.

13. The electric product of claim 11, wherein a flow tube is hollow such that the fire extinguishing agent flows through the flow tube, and
wherein a spray body is connected to the flow tube and is configured to spray the fire extinguishing agent toward the battery cells.

14. The electric product of claim 13, wherein the spray body is rotatably connected to the flow tube and is capable of adjusting the spraying path of the fire extinguishing agent.

15. The electric product of claim 14, wherein the spraying unit further comprises a pressurizing unit that is connected to the flow tube and is configured to supply pressure to the fire extinguishing agent flowing in the flow tube.

16. The electronic device of claim 11, further comprising a guiding unit arranged between the spraying unit and the battery cells, the guiding unit being configured to guide the fire extinguishing agent sprayed from the spraying unit to the battery cells.

17. The electric product of claim 16, wherein the guiding unit comprises:
a guide plate covering an outer side of the plurality of battery cells; and
a guide body connected to the guide plate and configured to allow the fire extinguishing agent to pass therethrough.

18. The electric product of claim 17, wherein the guide body is provided as a plurality of guide bodies each of which corresponds to one of the battery cells.

19. The electric product of claim 11, further comprising a temperature sensor unit arranged inside the pack housing and configured to detect a temperature of the battery cells.

20. The electric product of claim 11, further comprising a control unit electrically connected to the spraying unit and configured to control the spraying path of the fire extinguishing agent.
